(19) United States
(12) Patent Application Publication
(10) Pub. No.: US 2024/0149230 A1
(43) Pub. Date: May 9, 2024

(54) DEVICE FOR ACCELERATING REACTION OF SUBSTANCE TO BE STIRRED

(71) Applicant: HADO Co.,Ltd., Incheon (KR)

(72) Inventor: Taejun OK, Seoul (KR)

(21) Appl. No.: 18/465,279

(22) Filed: Sep. 12, 2023

(30) Foreign Application Priority Data
Nov. 3, 2022 (KR) 10-2022-0145265

(51) Int. Cl. B01F 27/113; B01F 23/10; B01F 27/115; B01F 27/192; B01F 27/2122; B01F 27/2123; F04D 19/02

(52) U.S. Cl. CPC B01F 27/113; B01F 23/14; B01F 27/115; B01F 27/192; B01F 27/2122; B01F 27/2123; F04D 19/02; B01F 2101/2204

(57) ABSTRACT

Provided is a device for accelerating reaction of substances to be stirred, the device including: a hollow shaft having at least one or more shaft holes formed thereon; a fixing shaft disposed inside the hollow shaft in such a way as to protrude downward; a lower disc fitted to the fixing shaft; a gas-inducing impeller located on top of the lower disc and having a plurality of blades each consisting of a pair of a long blade and a short blade, the long blades protruding outward from the space between the lower disc and an upper disc; the upper disc fitted to the fixing shaft in such a way as to be spaced apart from the lower disc on the lower periphery of the hollow shaft and having an inlet hole formed at the center thereof; and a general impeller fitted to the lower end of the fixing shaft.

### BACKGROUND OF THE DISCLOSURE

### Cross Reference to Related Application of the Disclosure

The present application claims the benefit of Korean Patent Application No. 10-2022-0145265 filed in the Korean Intellectual Property Office on Nov. 3, 2022, the entire contents of which are incorporated herein by reference.

### FIELD OF THE DISCLOSURE

The present disclosure relates to a device for accelerating the reaction of substances to be stirred, more particularly to a device for accelerating the reaction of substances to be stirred that is capable of allowing a gas-inducing impeller consisting of blades with different lengths to be combined to a hollow shaft having one or more holes formed on the upper portion thereof, thereby improving the flow rates of the substances to be stirred and the transfer force between the substances.

### BACKGROUND OF THE RELATED ART

Generally, a stirrer is a device that stirs and mixes a liquid and a liquid or a liquid and a solid or powder, which is widely used in a process where objects have to be mixed, such as a chemical process, a wastewater treatment process, and the like.

The stirrer is largely classified into a tank stirrer and a fluid stirrer according to the types of stirring, and at present, most of stirrers are tank stirrers.

The tank stirrer, which is configured to put a stirrer in a tank, is classified into various types, such as a propeller type, a paddle type, a turbine type, and a helical type according to types of stirring blades. The propeller stirrer is also used for the agitation of liquids with low viscosity or liquids containing solid particles, and the paddle stirrer is used for low viscosity and has the simplest structure among the stirrers. The turbine stirrer uses a centrifugal force and is quite efficient. The helical stirrer is used in stirring objects with high viscosity.

The stirrer has to have an impeller with blades adapted to stir and mix a liquid and a liquid or a liquid and a solid or powder.

Further, the stirrer is used in an aeration device or flocculation device of a wastewater purification treatment facility to perform a stirring process that induces an active reaction between oxygen or flocculant and wastewater to be treated.

One of conventional stirrers is disclosed in Korean Patent No. 10-1949947 (Dated on Feb. 19, 2019) entitled ‘Gas inducing pipe and impeller using same’. The conventional impeller includes: a solid shaft whose portion is disposed inside a liquid and having a bracket; a blade unit disposed on the portion of the solid shaft located inside the liquid and having at least one or more vertical blades; and at least one or more gas-inducing pipes disposed on the outer periphery of the solid shaft in a longitudinal direction of the solid shaft in such a way as to be seated onto the bracket. Each gas-inducing pipe has a hollow portion formed therein in a longitudinal direction thereof, and one end of the hollow portion serves as an inlet. The inlet is located at the outside of the liquid to introduce gas into the hollow portion, and a portion of the hollow portion is bent slantly in such a way as to be located toward the outside of the blade unit from the inside thereof. In this case, the end of the bent portion as the other end of the hollow portion serves as an outlet, and the outlet is located at the rear surface of the corresponding vertical blade. Accordingly, the induced gas to the hollow portion from the inlet is emitted to the liquid through the outlet.

In the above-mentioned conventional configuration, a self-inducing impeller, which induces a gas existing above the surface of the liquid in the tank to the liquid, has been generally used. In the case of reaction using a high-priced gas, the gas having no reaction yet, which exists above the surface of the liquid in the tank, is induced downward to the liquid, thereby enhancing the efficiency of the reaction.

To allow the gas to be sucked to the liquid in the conventional practice, generally, revolutions per minute are raised to increase the contact areas between the gas and the liquid, so that the gas is absorbed to the liquid to increase an amount of gas.

Because of a density difference between gas and liquid, the gas moves up strongly, and accordingly, after the gas is emitted from the end of the impeller, the gas moves up fast. Even if the amount of gas increases, however, the flow rates of substances among the structures in the tank do not increase, or the transfer efficiencies of the substances to be stirred are not improved.

### PRIOR ART LITERATURE

### Patent Literature

(Patent Literature 1) Korean Patent No. 10-1949947 (Dated on Feb. 19, 2019)

### SUMMARY OF THE DISCLOSURE

Accordingly, the present disclosure has been made in view of the above-mentioned problems occurring in the related art, and it is an object of the present disclosure to provide a device for accelerating the reaction of substances to be stirred that is capable of allowing a gas-inducing impeller consisting of blades with different lengths to be combined to a hollow shaft having at least one or more shaft holes, thereby improving the flow rates of the substances to be stirred and the transfer force between the substances.

It is another object of the present disclosure to provide a device for accelerating the reaction of substances to be stirred that is capable of allowing blades to protrude outward from the space between discs to improve the flow rates of the substances to be stirred in a tank and allowing a portion of gas emitted between long and short blades to come into direct contact with the neighboring long blade to improve the transfer efficiencies between the substances to be stirred.

It is yet another object of the present disclosure to provide a device for accelerating the reaction of substances to be stirred that is capable of allowing the substances to be stirred in a tank to be sucked to a gap between an upper disc and a hollow shaft and primarily react to a gas that does not react yet, which is induced above the substances to be stirred, in the interior of a gas-inducing impeller, thereby enhancing the reaction speed of the substances to be stirred.

To accomplish the above-mentioned objects, according to the present disclosure, there is provided a device for accelerating the reaction of substances to be stirred, the device including: a hollow shaft rotatable by a drive unit and having at least one or more shaft holes formed thereon; a fixing shaft disposed inside the hollow shaft in such a way as to protrude downward; a lower disc fitted to the fixing shaft; a gas-inducing impeller located on top of the lower disc and having a plurality of blades each consisting of a pair of a long blade and a short blade, the long blades protruding outward from the space between the lower disc and an upper disc; the upper disc fitted to the fixing shaft in such a way as to be spaced apart from the lower disc on the lower periphery of the hollow shaft and having an inlet hole formed at the center thereof; and a general impeller fitted to the lower end of the fixing shaft.

According to the present disclosure, desirably, the substances to be stirred are sucked to the space formed between the hollow shaft and the inner peripheral surface of the inlet hole of the upper disc and react to a gas that does not react yet, the gas being induced to the substances above the surfaces of the substances through the hollow shaft, in the gas-inducing impeller.

According to the present disclosure, desirably, the lower disc has at least one or more introduction holes adapted to smoothly move the substances to be stirred.

According to the present disclosure, desirably, each pair of the long blade and the short blade is arranged in the shape of ‘V’, each long blade protrudes outward from the space between the lower disc and the upper disc, and each short blade is located inside the lower disc and the upper disc.

According to the present disclosure, desirably, each long blade allows some of the substances to be stirred in which the gas emitted between the long blade and the short blade is contained to come into direct contact with the neighboring long blade to accelerate the flow rates of the substances to be stirred.

According to the present disclosure, desirably, the upper disc has a slant plate disposed slant on top thereof to guide the substances to be stirred to the inside thereof when the substances to be stirred are supplied from the hollow shaft and the gas-inducing impeller.

According to the present disclosure, desirably, the general impeller moves the substances to be stirred in a tank upward, while interacting with the gas-inducing impeller, to allow the gas that does not react yet above the substances to be stirred to react to the substances to be stirred in the tank.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present disclosure will be apparent from the following detailed description of the embodiments of the disclosure in conjunction with the accompanying drawings, in which:

FIG. 1 is a perspective view showing a device for accelerating the reaction of substances to be stirred according to an embodiment of the present disclosure;

FIG. 2 is a bottom perspective view showing a bottom configuration of the device of FIG. 1;

FIG. 3 is a sectional view showing a configuration of the device of FIG. 1;

FIG. 4 is an exploded perspective view showing the device of FIG. 1;

FIG. 5 is a perspective view showing the device of FIG. 1 from which a hollow shaft is removed;

FIG. 6 is a top view showing a state where a gas-inducing impeller of FIG. 1 is mounted;

FIG. 7 is a perspective view showing a device for accelerating the reaction of substances to be stirred according to another embodiment of the present disclosure;

FIG. 8 is a perspective view showing a state where a gas-inducing impeller of the device of FIG. 7 is mounted;

FIG. 9 shows reaction speeds of substances to be stirred by a conventional stirrer and the device of the present disclosure;

FIG. 10 is a graph showing mass transfer coefficients of the conventional stirrer and the device of the present disclosure;

FIG. 11 is a graph showing air bubble sizes generated by the conventional stirrer and the device of the present disclosure;

FIG. 12 is a sectional view showing flow rates of gas emitted from the conventional stirrer and the gas-inducing impeller of the device of the present disclosure; and

FIG. 13 is an enlarged view showing a state where flow rates among the structures in the tank of the device of the present disclosure increase.

### DETAILED DESCRIPTION OF THE EMBODIMENTS

Hereinafter, an explanation on a configuration of a device for accelerating the reaction of substances to be stirred according to the present disclosure will be given.

A device for accelerating the reaction of substances to be stirred according to the present disclosure includes: a hollow shaft rotatable by a drive unit and having at least one or more shaft holes formed thereon; a fixing shaft disposed inside the hollow shaft in such a way as to protrude downward; a lower disc fitted to the fixing shaft; a gas-inducing impeller located on top of the lower disc and having a plurality of blades each consisting of a pair of a long blade and a short blade, the long blades protruding outward from the space between the lower disc and an upper disc; the upper disc fitted to the fixing shaft in such a way as to be spaced apart from the lower disc on the underside of the hollow shaft and having an inlet hole formed at the center thereof; and a general impeller fitted to the lower end of the fixing shaft, wherein a portion of the gas emitted between each long blade and each short blade comes into direct contact with the neighboring long blade to perform smooth transfer between the substances to be stirred, the long blades enhance the flow rates of the substances to be stirred to perform the acceleration of the reaction of the substances, the gas-inducing impeller consisting of the blades (that is, the long blades and the short blades) with different lengths is combined to the hollow shaft having the at least one or more shaft holes to improve the flow rates of the substances to be stirred, the transfer force between the substances, and the stirring force, and the lower disc has one or more introduction holes adapted to remove a region where the substances to be stirred remain, to achieve smooth flows of the substances.

Under the above-mentioned configuration, an explanation on the device for accelerating the reaction of substances to be stirred according to the present disclosure will be given in detail with reference to the attached drawings.

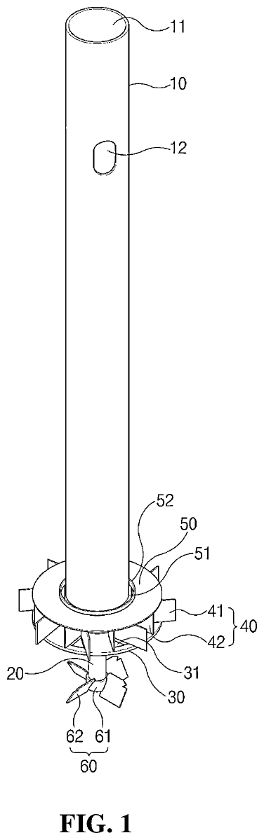

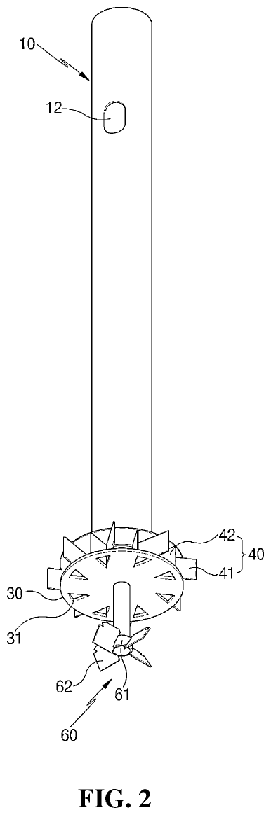

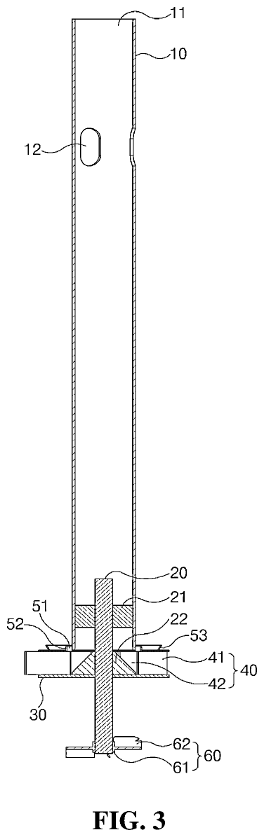

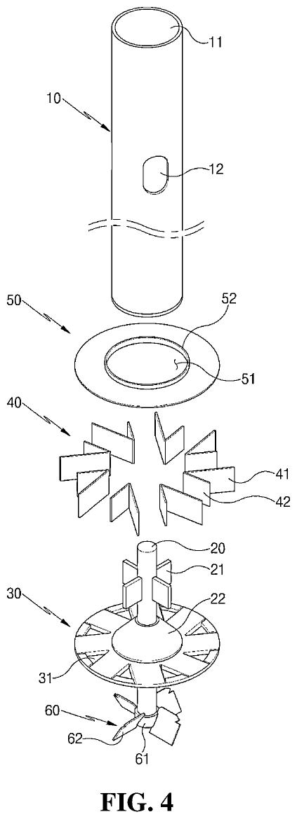

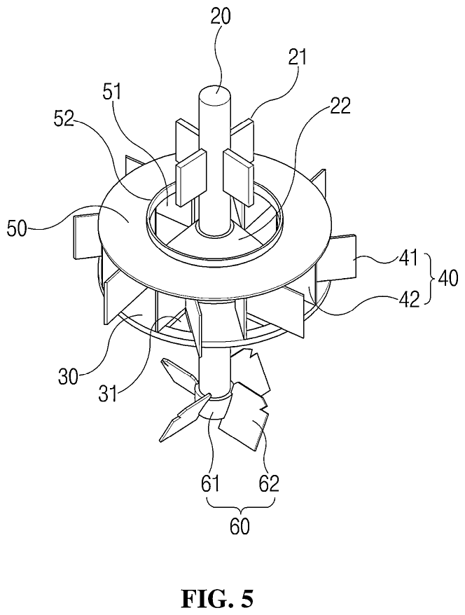

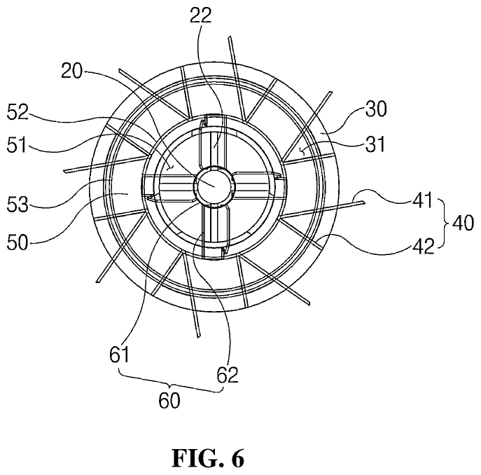

FIG. 1 is a perspective view showing a device for accelerating the reaction of substances to be stirred according to an embodiment of the present disclosure. FIG. 2 is a bottom perspective view showing a bottom configuration of the device of FIG. 1. FIG. 3 is a sectional view showing a configuration of the device of FIG. 1. FIG. 4 is an exploded perspective view showing the device of FIG. 1. FIG. 5 is a perspective view showing the device of FIG. 1 from which a hollow shaft is removed. FIG. 6 is a top view showing a state where a gas-inducing impeller of FIG. 1 is mounted.

Referring to FIG. 1, the device for accelerating the reaction of substances to be stirred according to an embodiment of the present disclosure includes a hollow shaft 10, a fixing shaft 20, a lower disc 30, a gas-inducing impeller 40, an upper disc 50, and a general impeller 60.

The hollow shaft 10 has a hollow portion 11 passing through from top to bottom thereof and a plurality of shaft holes 12 formed on an upper portion thereof, and the shaft holes 12 serve to prevent the substances to be stirred from remaining in the hollow shaft 10, thereby achieving smooth flows of the substances.

The hollow shaft 10 is connected to a drive unit, and the drive unit is either a motor or a motor coupled to a speed reducer.

The general impeller 60 is fittedly coupled to the fixing shaft 20 under the hollow shaft 10, and the gas-inducing impeller 40 is fitted to the fixing shaft 20 between the upper disc 50 and the lower disc 30.

The general impeller 60 moves up the substances (including the gas emitted) to be stirred and is an upward flowing type so that the substances react to each other around the gas-inducing impeller 40.

Further, the gas-inducing impeller 40 consisting of blades (that is, long blades 41 and short blades 42) with different lengths is combined to the hollow shaft 10 having the at least one or more shaft holes 12 to improve the flow rates of the substances to be stirred, the transfer force between the substance, and the stirring force.

Referring to FIG. 2, the upward flowing type general impeller 60 moves up the substances to be stirred and supplies the substances to the gas-inducing impeller 40. The substances introduced into the gas-inducing impeller 40 react actively around a region of the gas-inducing impeller 40 where flow rates are highest.

As shown, the general impeller 60 is fitted to the lower end of the fixing shaft 20, while being spaced apart from the lower disc 30 by a given distance, to smoothly supply the substances to be stirred to the gas-inducing impeller 40.

As shown, the general impeller 60 has a plurality of blades fitted slantly by a given angle to the outer peripheral surface of the fixing shaft 20 to supply the substances to be stirred to the gas-inducing impeller 40.

As shown, the lower disc 30 has at least one or more introduction holes 31 adapted to introduce the substances to be stirred moving upward by the general impeller 60 thereinto, so that the substances to be stirred are prevented from remaining in a space between the upper disc 50 and the lower disc 30, thereby achieving smooth flows of the substances to be stirred.

Referring to FIGS. 3 to 6, the device for accelerating the reaction of the substances to be stirred according to the embodiment of the present disclosure includes the hollow shaft 10, the fixing shaft 20, the lower disc 30, the gas-inducing impeller 40, the upper disc 50, and the general impeller 60.

In more specific, the hollow shaft 10 has the hollow portion 11 passing through from top to bottom thereof and the plurality of shaft holes 12 formed on the outer peripheral surface thereof.

The fixing shaft 20 is disposed inside the hollow shaft 10 in such a way as to insert one side thereof into the hollow portion 11 and protrudes downward. Further, the fixing shaft 20 has a plurality of fixing panels 21 mounted thereon by means of welding.

Further, the fixing shaft 20 has a fixing body 22 having the shape of a cone fitted thereto at a position distant by a given distance from the fixing panels 21, and the fixing body 22 has a coupling hole passing through top to bottom thereof.

The lower disc 30 is located on the underside of the fixing body 22 fitted to the fixing shaft 20 to fix the gas-inducing impeller 40 thereto, while preventing the substances being stirred through the general impeller 60 from remaining in the space between the lower disc 30 and the upper disc 50.

Further, the lower disc 30, which is a circular plate, has the at least one or more introduction holes 31 formed along the periphery thereof, and the introduction holes 31 serve to prevent the substances to be stirred located between the lower disc 30 and the upper disc 50 from remaining due to the substances being stirred supplied from the general impeller 60 fitted to the fixing shaft 20 to the hollow shaft 10.

The gas-inducing impeller 40 is configured to allow each pair of the long blade and the short blade to be located around each introduction hole 31 of the lower disc 30, thereby serving to stir the substances. The gas-inducing impeller 40 has the plurality of blades each having the pair of the long blade 41 and the short blade 42 crossing each other to the shape of ‘V’, thereby easily stirring the substances to be stirred.

That is, each pair of the long blade 41 and the short blade 42 arranged in the shape of ‘V’ is located in the space between the lower disc 30 and the upper disc 5, and each long blade 41 protrudes outward from the space between the lower disc 30 and the upper disc 50.

The long blades 41, which are located in the space between the lower disc 30 and the upper disc 5 in such a way as to protrude outward from the space between the lower disc 30 and the upper disc 50, serve to improve the flow rated in a tank upon stirring and to allow a portion of the gas emitted between each long blade 41 and each short blade 42 to come into direct contact with the neighboring long blade 41 to improve transfer efficiencies between the substances to be stirred.

The short blades 42 are located inside the lower disc 30 and the upper disc 50 and serve to allow the substances to be stirred located between the lower disc 30 and the upper disc 50 to be discharged to the outside, together with the long blades 41.

The substances to be stirred, which are introduced into the plurality of introduction holes 31 of the lower disc 30 through the general impeller 60, are introduced between each pair of the long blade 41 and the short blade 42 arranged to the shape of the ‘V’ and prevented from remaining in the space between the lower disc 30 and the upper disc 50, while the flow rates of the substances to be stirred are being fast by means of the long blades 41.

The substances to be stirred, which are discharged between the upper disc 50 and the lower disc 30 by means of the long blades 41 and the short blades 42, react actively on the region where the flow rates around the gas-inducing impeller 40 are fast because the gas is induced to move up by the general impeller 60.

The upper disc 50, which is a circular plate, has an inlet hole 51 formed at the center thereof and a protruding plate 52 protruding from the circumference of the inlet hole 51.

The substances to be stirred, which move up by the rotations of the gas-inducing impeller 40, are introduced into the space (or gap) between the hollow shaft 10 and the inner peripheral surface of the inlet hole 51 and then discharged to the outside of the space between the lower disc 30 and the upper disc 50, so that the flow rates around the gas-inducing impeller 40 become fast.

That is, the substances to be stirred, which are sucked to the space formed between the hollow shaft 10 and the inner peripheral surface of the inlet hole 51 of the upper disc 50, react to the gas that does not react yet, which is induced to the substances above the surface of the substances through the hollow shaft 10, in the gas-inducing impeller 40.

The general impeller 60 has a fixing pipe 61 fitted to the lower end of the fixing shaft 20 and a plurality of general blades 62 spaced apart from one another by a given distance along the fixing pipe 61 to transfer the substances to be stirred in an upward direction.

The general impeller 60 is fitted to the lower end of the fixing shaft 20 inserted inside the hollow shaft 10 in such a way as to protrude downward from the lower disc 30 and moves the substances in the tank up to the gas-inducing impeller 40, so that the substances to be stirred react actively to the substances to be stirred around the gas-inducing impeller 40.

Further, the general impeller 60 moves the substances in the tank upward, while interacting with the gas-inducing impeller 40, to allow the gas that does not react yet above the substances to be stirred to react to the substances to be stirred in the tank.

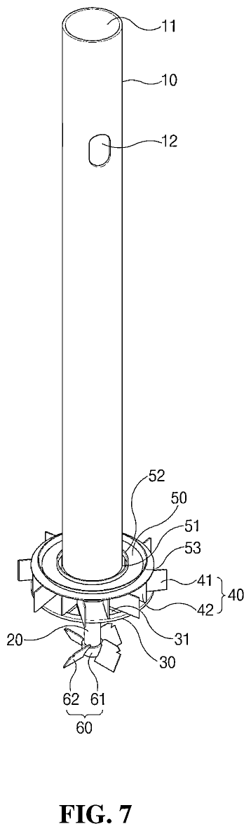

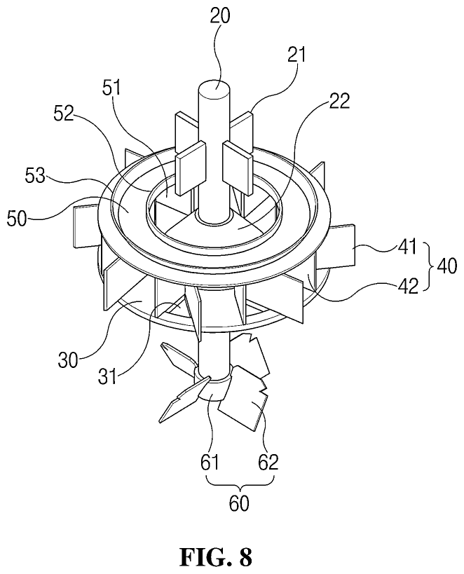

The device for accelerating the reaction of substances to be stirred according to the present disclosure is not limited to the configuration as shown in FIGS. 1 to 6, and further, the device may be configured as shown in FIGS. 7 and 8.

FIG. 7 is a perspective view showing a device for accelerating the reaction of substances to be stirred according to another embodiment of the present disclosure, and FIG. 8 is a perspective view showing a state where a gas-inducing impeller of the device of FIG. 7 is mounted.

Referring to FIGS. 7 and 8, the device for accelerating the reaction of substances to be stirred according to another embodiment of the present disclosure includes a hollow shaft 10, a fixing shaft 20, a lower disc 30, a gas-inducing impeller 40, an upper disc 50, and a general impeller 60. In this case, the hollow shaft 10, the fixing shaft 20, the lower disc 30, the gas-inducing impeller 40, and the general impeller 60 have the same configuration as suggested in FIGS. 1 to 6, and therefore, explanations of the components will be avoided.

However, the upper disc 50 is configured differently from that as shown in FIGS. 1 to 6, and therefore, an explanation of the upper disc 50 will be given below.

The upper disc 50, which is a circular plate, has an inlet hole 51 formed at the center thereof, a protruding plate 52 protruding from the circumference of the inlet hole 51, and a circular slant plate 53 disposed slant by a given angle at a position spaced apart from the protruding plate 52 by a given distance.

Further, the slant plate 53 serves to guide the substances to be stirred to the inside of the upper disc 50 when the substances to be stirred are supplied from the hollow shaft 10 and the gas-inducing impeller 40.

The slant plate 53, which is located around the outer periphery of top of the upper disc 50, prevents the substances to be stirred circulated in the tank from colliding against the substances to be stirred around the region where the gas-inducing impeller 40 is located, thereby allowing the flow rates around the gas-inducing impeller 40 to become fast.

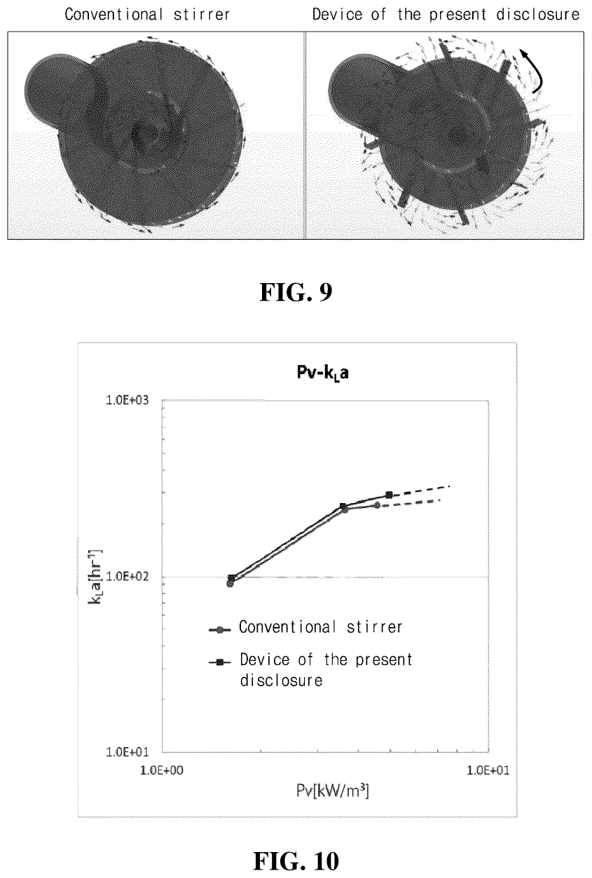

FIG. 9 shows reaction speeds of substances to be stirred by a conventional stirrer and the device of the present disclosure. In a state where the device of the present disclosure is disposed in the tank, the flow rates of the substances to be stirred in the device of the present disclosure are compared with those in the conventional general stirrer. As shown in FIG. 9, as a result, it is checked that the flow rates of the substances (including the gas emitted) discharged from the gas-inducing impeller 40 in the device of the present disclosure become fast to accelerate the reaction of the substances to be stirred.

Through the fast flow rates, variations of mass transfer coefficients are shown in FIG. 10. FIG. 10 is a graph showing mass transfer coefficients of the conventional stirrer and the device of the present disclosure.

The mass transfer coefficients K L a are compared between the conventional stirrer and the device of the present disclosure, as shown in FIG. 10, and as a result, it is found that the mass transfer coefficients K L a according to volume in the device of the present disclosure are higher than those in the conventional stirrer.

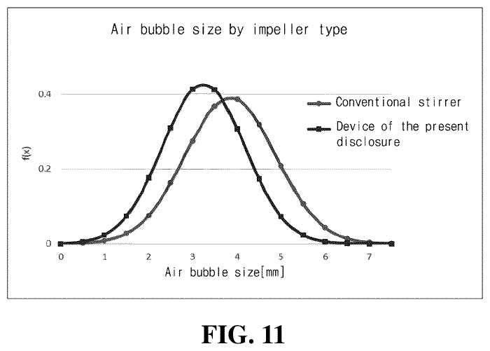

FIG. 11 is a graph showing air bubble sizes generated by the conventional stirrer and the device of the present disclosure.

In this case, it is appreciated from the graph of FIG. 11 that the sizes of the air bubbles generated around the gas-inducing impeller 40 are smaller than those generated by the conventional stirrer. If the air bubble sizes are small, that is, the transfer and reaction of the substances are efficiently performed.

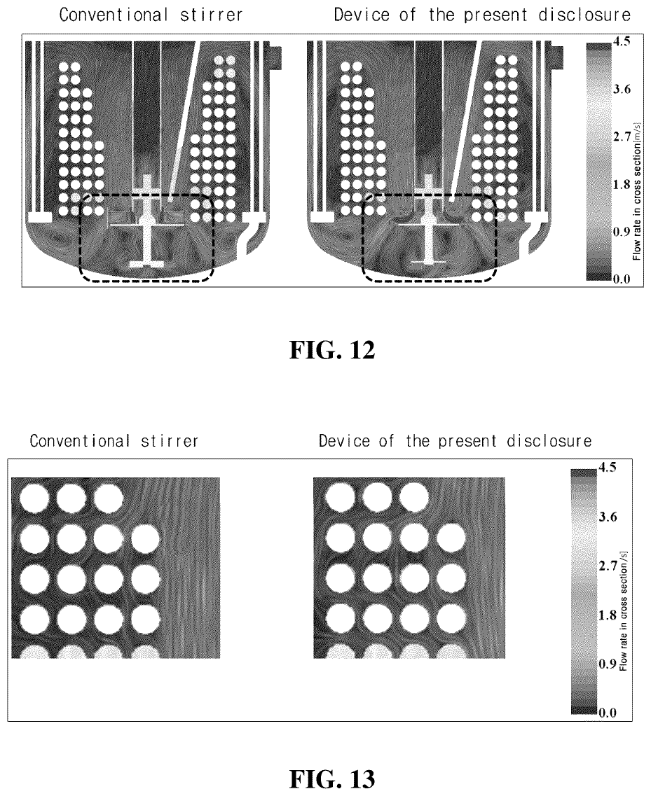

The flow rates of the substances discharged from the gas-inducing impeller 40 in the device of the present disclosure are compared with those of the substances discharged in the conventional stirrer, as shown in FIGS. 12 and 13. FIG. 12 is a sectional view showing flow rates of gas emitted from the conventional stirrer and the gas-inducing impeller of the device of the present disclosure, and FIG. 13 is an enlarged view showing a state where flow rates among the structures in the tank of the device of the present disclosure increase.

As shown in FIGS. 12 and 13, it is found that the flow rates of the substances discharged from the gas-inducing impeller 40 of the device of the present disclosure are faster than those of the substances discharged by the conventional stirrer.

The flow rates of the substances to be stirred become fast by means of the gas-inducing impeller 40, thereby removing the region where the substances to be stirred remain, generating smooth flows of the substances to be stirred, and improving the transfer efficiencies between the substances to be stirred.

Further, a portion of the gas emitted between each long blade 41 and each short blade 42 comes into direct contact with the neighboring long blade 41 to perform smooth substance transfer, and the flow rates of the substances to be stirred are fast by means of the long blades 41 to perform the acceleration of the reaction of the substances.

Further, the gas-inducing impeller 40 consisting of the blades (that is, the long blades 41 and the short blades 42) with different lengths is combined to the hollow shaft having the at least one or more shaft holes 12, thereby improving the flow rates of the substances to be stirred, the transfer force between the substances, and the stirring force, and one or more introduction holes 31 of the lower disc 30 are adapted to remove the region where the substances to be stirred remain, thereby achieving smooth flows of the substances.

The flow rates among the structures in the tank are fast by means of the gas-inducing impeller 40, the general impeller 60, the introduction holes 31 of the lower disc 30, and the inlet hole 51 of the upper disc 50, thereby improving the transfer efficiencies between the substances to be stirred, as shown in FIGS. 12 and 13.

Unlike the conventional general impeller wherein the gas emitted therefrom is absorbed to the substances to be stirred, without being distributed, the device for accelerating the reaction of substances to be stirred according to the present disclosure can allow a portion of the gas emitted between each long blade and each short blade to come into direct contact with the neighboring long blade, thereby achieving smooth transfer between the substances to be stirred, and allow the long blades protruding outward to improve the flow rates of the substances to be stirred, thereby accelerating the reaction of the substances.

Further, the device for accelerating the reaction of substances to be stirred according to the present disclosure can allow the gas-inducing impeller consisting of the blades (the long blades and the short blades) with different lengths to be combined to the hollow shaft having the at least one or more shaft holes, thereby improving the flow rates of the substances to be stirred and the transfer efficiencies between the substances.

Moreover, the device for accelerating the reaction of substances to be stirred according to the present disclosure can allow the one or more introduction holes of the lower disc to serve to remove the region where the substances to be stirred remain, thereby achieving smooth flows of the substances.

Further, the device for accelerating the reaction of substances to be stirred according to the present disclosure can allow the upward flowing type general impeller located under the gas-inducing impeller to move up the substances to be stirred, thereby permitting the substances to actively react to each other around the region of the gas-inducing impeller 40 where the flow rates are fastest.

In addition, the device for accelerating the reaction of substances to be stirred according to the present disclosure can allow the flow rates among the structures in the tank to be improved by means of the gas-inducing impeller, the general impeller, and the holes formed on the lower disc and the upper disc, thereby improving the transfer efficiencies between the substances to be stirred.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. A device for accelerating reaction of substances to be stirred, the device comprising:
a hollow shaft (10) rotatable by a drive unit and having at least one or more shaft holes (12) formed thereon;
a fixing shaft (20) disposed inside the hollow shaft (10) in such a way as to protrude downward;
a lower disc (30) fitted to the fixing shaft (20);
a gas-inducing impeller (40) located on top of the lower disc (30) and having a plurality of blades each consisting of a pair of a long blade (41) and a short blade (42), the long blades (41) protruding outward from the space between the lower disc (30) and an upper disc (50);
the upper disc (50) fitted to the fixing shaft (20) in such a way as to be spaced apart from the lower disc (30) on the lower periphery of the hollow shaft (10) and having an inlet hole (51) formed at the center thereof; and
a general impeller (60) fitted to the lower end of the fixing shaft (20).

2. The device according to claim 1, wherein the substances to be stirred are sucked to the space formed between the hollow shaft (10) and the inner peripheral surface of the inlet hole (51) of the upper disc (50) and react to a gas that does not react yet, the gas being induced to the substances above the surfaces of the substances through the hollow shaft (10), in the gas-inducing impeller (40).

3. The device according to claim 1, wherein the lower disc (30) has at least one or more introduction holes (31) adapted to smoothly move the substances to be stirred.

4. The device according to claim 1, wherein each pair of the long blade (41) and the short blade (42) is arranged in the shape of ‘V’, each long blade (41) protrudes outward from the space between the lower disc (30) and the upper disc (50), and each short blade (42) is located inside the lower disc (30) and the upper disc (50).

5. The device according to claim 1, wherein each long blade (41) allows some of the substances to be stirred in which the gas emitted between the long blade (41) and the short blade (42) is contained to come into direct contact with the neighboring long blade (41) to accelerate the flow rates of the substances to be stirred.

6. The device according to claim 1, wherein the upper disc (50) has a slant plate (53) disposed slant on top thereof to guide the substances to be stirred to the inside thereof when the substances to be stirred are supplied from the hollow shaft (10) and the gas-inducing impeller (40).

7. The device according to claim 1, wherein the general impeller (60) moves the substances to be stirred in a tank upward, while interacting with the gas-inducing impeller (40), to allow the gas that does not react yet above the substances to be stirred to react to the substances to be stirred in the tank.
